(19) United States
(12) Patent Application Publication
(10) Pub. No.: US 2009/0228125 A1
(43) Pub. Date: Sep. 10, 2009

(54) PROCESSING OF HETEROGENEOUS MEDIA IN A MOBILE COMPUTING DEVICE

(76) Inventor: William Stewart, Los Altos, CA (US)

Correspondence Address: Knobbe, Martens, Olson & Bear, LLP, 2040 Main Street, Fourteenth Floor, Irvine, CA, 92614, US

(21) Appl. No.: 12/133,303

(22) Filed: Jun. 4, 2008

Related U.S. Application Data
(60) Provisional application No. 61/033,763, filed on Mar. 4, 2008.

(51) Int. Cl. G06F 17/00

(52) U.S. Cl. 700/94

(57) ABSTRACT

Embodiments of the present disclosure provide a media server for a mobile computing device that can efficiently arbitrate media content, such as audio or video, among a plurality of client applications. In some embodiments, audio from the client applications is handled based on buffers in an audio queue. The media server is capable of arbitrating both compressed and uncompressed audio in these buffers with the availability of various resources, such as a decompressor. In addition, the media server is capable of scheduling various commands that support the audio in the buffers. For example, in some embodiments, the media server may be able to schedule various commands in advance of a format change in the audio. Other commands may also be scheduled, such as, transitions between compressed and uncompressed audio, digital rights management operations, and the like.

### REFERENCE TO RELATED APPLICATIONS

The present application claims priority to U.S. Provisional Application No. 61/033,763, filed Mar. 4, 2008, and entitled PROCESSING OF HETEROGENEOUS MEDIA IN A MOBILE COMPUTING DEVICE, the entire contents of which is hereby incorporated by reference in its entirety and should be considered a part of this specification.

### BACKGROUND

1. Field

Embodiments of the present disclosure relate to media content and, more particularly, to providing audio or video content on a portable media device.

2. Description of the Related Technology

Conventionally, portable devices may provide an audio (as well as visual) output. This allows applications, such as games and other applications, to play sounds on the device. The device may also be capable of recording audio.

However, various applications may handle audio and video content differently. For example, different applications may use compressed or uncompressed audio. The audio may also be formatted in different ways or protected by various digital rights management (DRM) schemes. These differences in audio, and often hardware constraints, may result in poor playback quality or gaps and interruptions in the playback of the audio.

Unfortunately, it can be difficult for a portable device to handle these different types of audio or video demands, and provide a seamless, high quality playback or recording of audio. Accordingly, it may be desirable to allow for efficient processing of media content on a mobile computing device.

### BRIEF DESCRIPTION OF THE DRAWINGS

The present disclosure will now be described in detail below in connection with the following figures in which:

FIG. 1 illustrates an exemplary block diagram of a device configured to provide efficient processing of media content, such as audio, according to an embodiment of the disclosure;

FIG. 2 illustrates an exemplary audio queue, according to an embodiment of the disclosure;

FIG. 3A illustrates a sequence of steps that can be performed by the device of FIG. 1, according to an embodiment of the disclosure;

FIG. 3B illustrates exemplary methods for playing media content, according to an embodiment of the disclosure;

FIG. 4A illustrates an example mobile device, according to an embodiment of the disclosure;

FIG. 4B illustrates an example of a configurable top-level graphical user interface of a mobile device, according to an embodiment of the disclosure; and

FIG. 5 is a block diagram of an example implementation of a mobile device, according to an embodiment of the disclosure.

### DETAILED DESCRIPTION

Embodiments of the present disclosure provide a media server for a mobile computing device that can efficiently arbitrate and control various media, including audio or video, among a plurality of client applications. In some embodiments, audio from the client applications can be handled based on buffers in an audio queue. The media server is capable of arbitrating both compressed and uncompressed audio in these buffers with the availability of various resources. The resources may include hardware components, such as a decompressor.

In addition, the media server is capable of scheduling various commands that support the audio in the buffers. For example, in some embodiments, the media server may be able to schedule various commands in advance of a format change in the audio. Other commands may also be scheduled, such as, transitions between compressed and uncompressed audio, digital rights management operations, and the like. This may be advantageous for media that may have portions encoded by different codecs, including, for example, audio video interleave (AVI) formatted files or DRM schemes, such as Apple FairPlay™.

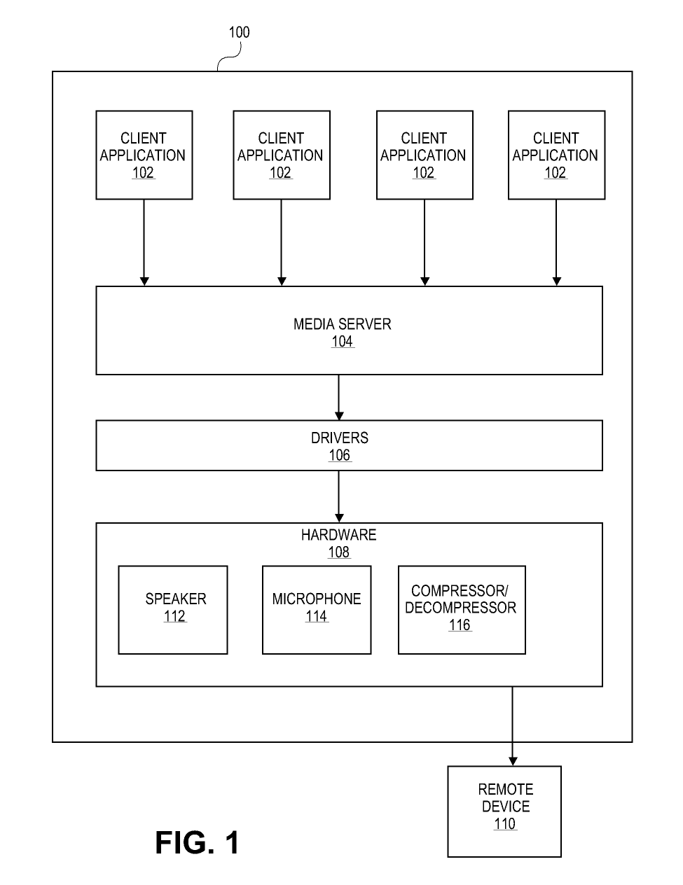

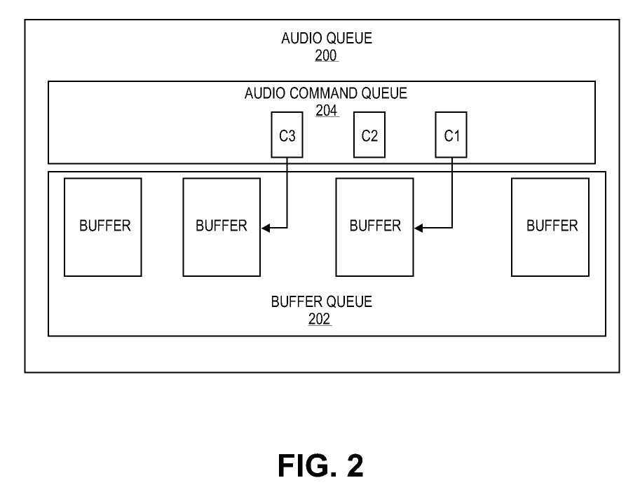

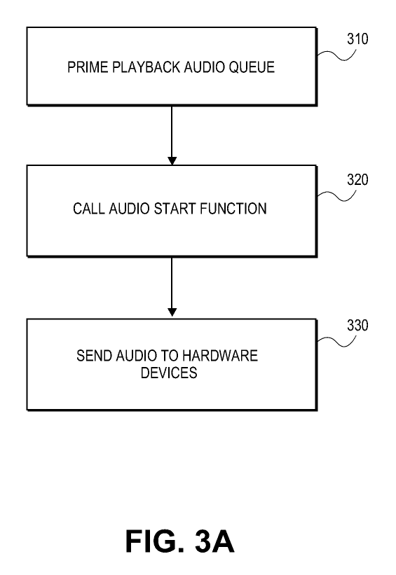

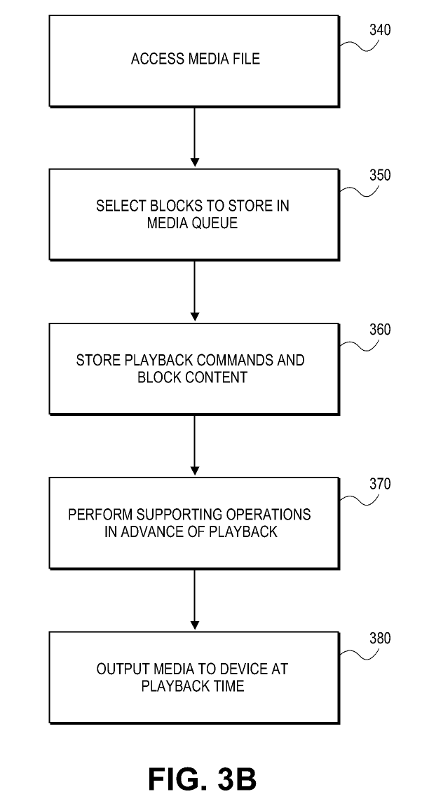

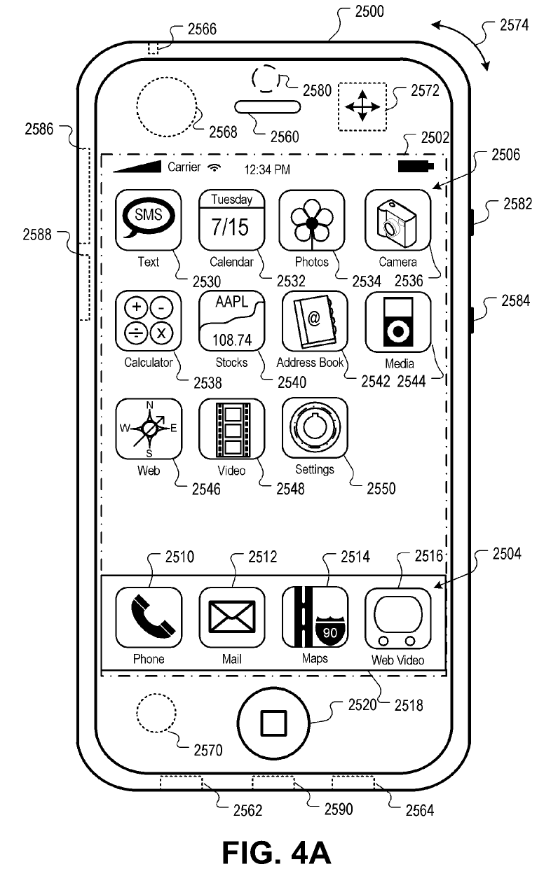

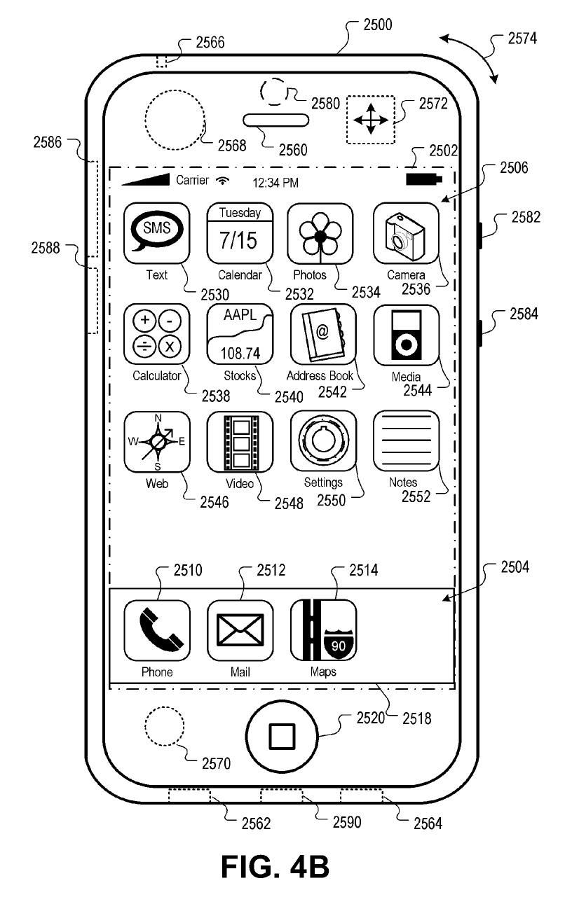

In order to help illustrate the embodiments, FIGS. 1-5 will now be presented. FIG. 1 is first provided to illustrate an exemplary device and its related audio components that support efficient processing of media content. FIG. 2 is then provided to illustrate various aspects of how the device can process various audio content. FIGS. 3A-B provide several flow charts of methods to play and record media content. FIGS. 4A-B and 5 illustrate embodiments of an exemplary device that may employ the media server of FIG. 1 and audio queue of FIG. 2.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

FIG. 1 illustrates an exemplary block diagram of a device 100 configured to provide efficient processing of media content, including audio. As shown, embodiments of the present disclosure may be implemented on a device 100. Device 100 may be any form of computing device, such as a computer or mobile computing device. For example, in some embodiments, device 100 may be a mobile phone. Those skilled in the art should recognize that device 100 may be equipped with typical audio and visual components, such as display screen, microphone, speakers, and the like. In addition, device 100 may include various communications interfaces, such as a serial bus port, a wireless network interface, or wired network interface. Other examples of device 100 may be found with reference to FIGS. 4A-B and 5.

Device 100 may run various client applications 102. Client applications 102 may be any form of application, such as a third party application, game, web application, video application, audio application, and the like. Of course, client applications 102 may utilize audio as an input or output.

Accordingly, as shown, device 100 may comprise various components to support the audio functions, for example, of client applications 102. In particular, device 100 may include a media server 104, various drivers 106, and hardware 108. In addition, device 100 may be coupled to a remote device 110 via a network or other type of link.

Media server 104 may serve as a control process that services the audio functions requested by client applications 102. For example, media server 104 may provide MIDI capabilities and representations of the complexities of MIDI devices to applications, and a MIDI I/O service. Media server 104 may also provide virtual sources and destinations allowing the routing of MIDI data between applications. Likewise, media sever 104 may also provide for the control and servicing of video and graphics functions that may be requested by client applications 102.

In addition, media server 104 may provide an Audio Hardware Abstraction Layer (Audio HAL). The Audio HAL may serve as the interface between client applications 102 and the hardware 108. For example, Audio HAL can allow for easy manipulation of devices through both an Input/Output procedure for streaming, and a simplified mechanism for control.

Additionally, media server 104 may provide integration with any kind of development for other program code, such as the Java Platform or Objective-C. High level functionalities may be accessible, for example, through a set of corresponding Java or Objective-C APIs.

Drivers 106 may be any software that allows media server 104 and client applications 102 to interact with hardware 108. For example, drivers 106 may comprise a graphics card driver or sound card driver.

Hardware 108 generally represents any media hardware that may be included with device 100. For example, device 100 is shown with a speaker 112, a microphone 114, and an audio decompressor 116. Of course, other hardware components may be included in device 100, such as additional speakers (internal or external), a keyboard, a mouse, a display, a printer, sound card, video card, etc.

Remote device 110 may be any device that can be coupled to device 100, including additional speakers or a network device, such as a hub or base station. Remote device 110 may be coupled to device 100 via a wireless or wired connection. In addition, remote device 110 may be coupled to device 100 via a network.

For example, remote device 110 may be an AirPort™ or AirTunes™ device from Apple, Inc., which has been coupled to device 100 and allows device 100 to send a stream of music to other devices (not shown).

Now that some of the basic software and hardware components have been explained, reference will now be made to FIG. 2. FIG. 2 shows an exemplary audio queue that may be employed by device 100 to manage its audio functions. As shown, an audio queue 200 is illustrated. Audio queue 200 may be any software object, including a list, map, stack, etc. that can be used for recording or playing audio in device 100. In general, audio queue 200 may be used to connect to audio hardware in hardware 108, manage memory used for the audio, employ codecs, as needed, for compressed audio formats, and provide a framework for mediating recording or playback of audio.

In general, audio queue 200 may include a set of audio queue buffers, each of which is a temporary repository for some audio data; a buffer queue 202, which is an ordered list for the audio queue buffers; and an audio queue callback function. As noted, audio queue buffers can be arranged in a sequence called buffer queue 202. The audio queue buffers can be numbered according to the order in which they are filled—which may be the same order in which they are handed off to the callback.

During playback, the callback is on the input side. The callback may be responsible for obtaining audio data from disk (or other source) and handing it off to the audio queue 200. Playback callbacks can also tell their audio queues to stop when there is no more data to play.

A playback audio queue's output may typically connect to external audio hardware, such as a loudspeaker. In the default case, the audio goes to the system's default audio output device.

An audio queue 200 can use any number of buffers. Audio queues 200 may perform memory management for their buffers.

When receiving audio data, one audio queue buffer is being filled with audio data acquired from an input device, such as a microphone 114. The remaining buffers in the buffer queue 202 are lined up behind the current buffer, waiting to be filled with audio data in turn.

The audio queue 200 hands off filled buffers of audio data to their respective callback function in the order in which they were acquired. When a buffer is filled, the audio queue 200 may invoke the callback, handing it the full buffer. The callback then writes the contents of the buffer to an audio file, for example, in storage (not shown) of device 100.

Meanwhile, the audio queue 200 may fill another buffer with freshly acquired data. Once a buffer's contents have been stored, it may be put in line to be filled again. Processing may then repeat where the audio queue 200 again invokes the callback, handing it the next full buffer. The callback writes the contents of this buffer to the audio file in storage, and so forth. This looping steady state may continue until audio output stops.

When playing audio, one audio queue buffer is being sent to an output device, such as a loudspeaker. The remaining buffers in the buffer queue are lined up behind the current buffer, waiting to be played in turn.

Of note, in some embodiments, audio queue 200 may comprise a command queue 204. As an example, this command queue 204 is shown with commands C1, C2, and C3. These commands may be executed by the callback function to help support playback or recording of the audio. For example, commands C1 and C3 may be a command that sets the format to be used for the audio in their respective buffers. In addition, command C2 may allow for the format to be changed for audio in a different buffer. Of course, other commands may be executed asynchronously, such as a ring tone or system warning that is requested by device 100.

The command queue 204 thus allows media server 104 to schedule various events or commands for future audio processing. This feature, in some embodiments, allows for gapless or seamless playback of audio regardless of its format or other requirements, such as DRM processing, encoding, etc.

Of note, audio queue 200, may store various types of media, such as video content. For example, in an exemplary embodiment, a media file may support multiple codecs, such as AVI. Thus, the media file may be subdivided into a set of blocks or chunks that may each be encoded using different compression schemes, such as full frame (uncompressed), MPEG, Real Video, etc.

When the media file is read, media server 104 may read multiple chunks before their scheduled playback and arrange them in sequential order in the audio queue 200. The metadata for each chunk that describes the chunk content and encoding can be stored in audio command queue 204. The media content for each chunk may then be stored in the buffer queue 202. In this manner, the media may be decoded in advance of its scheduled playback to provide a seamless, high-quality playback of the media. A skilled artisan will recognize that a similar process may be performed when recording various media and storing the media in computer storage, such as a file.

Other commands may also be included in the audio command queue 204. For example, DRM commands, including Apple FairPlay™ may be placed in the command queue 204 so that device 100 can perform supporting operations related to DRM in advance of the audio in a buffer being played or recorded. In an exemplary embodiment, DRM commands associated with various media content may be prefetched and stored in the command queue 204 and associated with their respective content in the buffer queue 202. Thus, the DRM commands may be executed in advance of playback or recording to improve playback quality or recording speed by, for example, media server 104.

Of note, one skilled in the art will recognize that the command queue 204 may be integrated into the buffer queue 202. For example, the various commands may be simply inserted in stream with the audio buffers of buffer queue 202. As the commands in the buffer queue 202 are reached, the callback function or other processing may then be performed.

In order to help illustrate embodiments of the present disclosure, a brief description of playback of audio will now be described with respect to FIG. 3A. First, in block 310, media server 104 and client application 102 may prime the playback audio queue 200. For example, client application 102 may invoke a callback for each of the audio queue buffers, filling them and adding them to the buffer queue 202.

As noted, device 100 may support a plurality of client applications 102. Accordingly, the callbacks may be arbitrated by media server 104 for scheduling of resources in hardware 108. For example, media server 104 may schedule compressed and uncompressed audio in buffers of the audio queue 200 for processing by compressor/decompressor 116.

In addition, in view of the different audio requests from client applications 102, media server 104 may insert one or more commands in to the command queue 204. Of note, media server 104 may place commands in the command queue 204 based on anticipated transitions from one audio buffer to another that are in buffer queue 202. For example, media server 104 may insert commands in anticipation of a format change between audio buffers. Commands for minimizing or removing gaps in the audio may also be inserted.

Second, in block 320, when desired, client application 102 may make a call to an audio start function to begin playback of the audio in the buffer queue 202.

Third, in block 330, the audio queue 200 may begin sending audio buffers to the output devices in hardware 108, such as speaker 112. Once the first buffer has been played, the playback audio queue 200 may enter a looping steady state. The audio queue 200 starts playing the next buffer and invokes the callback, handing it the just-played buffer. The callback fills the buffer from the audio file and then enqueues it for playback, and so forth.

However, during playback, commands from the command queue 204 may be executed synchronously or asynchronously with playback of the audio buffers. For example, commands may be executed during transitions between buffers or in advance of the processing of their associated buffer. Other timing of command execution may also be supported. Accordingly, this feature allows media server 104 to flexibly handle many different types of audio workloads and formats, yet deliver a seamless or gapless output when desired.

FIG. 3B illustrates embodiments of exemplary methods for playing media content. The exemplary methods may be performed by client application 102 or media server 104, or alternatively, as one or more processes that may be accessible by client application 102 or media server 104. Depending on the embodiment, some of the blocks described below may be removed, others may be added, and the sequence of the blocks may be altered.

Beginning in block 340, a media file is accessed. The media file may include audio or video content, such as a QuckTime file. Media server 104 may access the file on its own during the normal processing of a media queue, such as audio queue 200. Alternatively, the media file may be accessed in response to a service request from client application 102 to media server 104 in order to utilize a media device, such as an audio or video card.

Moving to block 350, blocks that correspond to portions of the media file are selected and stored in media queue. In an embodiment where the media relates to audio content, the media queue may comprise audio queue 200. The blocks may be selected based on the order of presentation to a user using, for example, a first-in, first-out algorithm. However, some other selection process may be used, including a process that estimates the length of time needed to prepare the block for playback using, for example, a codec or DRM technology, such as Apple FairPlay™.

Next, in block 360, the playback commands and block content are stored. In an embodiment, block content may be selected and placed in a buffer queue 202 within audio queue 200. The playback commands associated with the block content may then be placed within audio command queue 204 and associated with their respective content in buffer queue 202.

Moving to block 370, supporting operations are then performed in advance of playback. Supporting operations may include, for example, DRM commands needed to digitally decrypt audio or video content to prevent unauthorized play. Additionally, commands related to decompression may be performed, such as decoding MP3 audio. The scheduling of supporting operations and access to hardware resources to perform such operations may be handled by media server 104.

Moving to block 380, the media content is outputted to the device at playback time. The playback of media content may be scheduled by media server 104. Once the media content has been played, the associated buffer within the buffer queue 202 may be freed and the process may repeat until there is no further media to output. A person skilled in the art will recognize that this process may be used for handling the recording of media content.

### Mobile Device Overview

FIG. 4A illustrates an example mobile device 2500. Mobile device 2500 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

In some implementations, mobile device 2500 includes touch-sensitive display 2502. Touch-sensitive display 2502 can be implemented with liquid crystal display (LCD) technology, light emitting polymer display (LPD) technology, or some other display technology. Touch-sensitive display 2502 can be sensitive to haptic and/or tactile contact with a user.

In some implementations, touch-sensitive display 2502 can include multi-touch-sensitive display 2502. Multi-touch-sensitive display 2502 can, for example, process multiple simultaneous touch points, including processing data related to the pressure, degree, and/or position of each touch point. Such processing may facilitate gestures and interactions with multiple fingers, chording, and other interactions. Other touch-sensitive display technologies can also be used (e.g., a display in which contact is made using a stylus or other pointing device). Some examples of multi-touch-sensitive display technology are described in U.S. Pat. Nos. 6,323,846, 6,570,557, 6,677,932, and 6,888,536, each of which is incorporated by reference herein in its entirety.

In some implementations, mobile device 2500 can display one or more graphical user interfaces on touch-sensitive display 2502 for providing the user access to various system objects and for conveying information to the user. In some implementations, the graphical user interface can include one or more display objects 2504, 2506. In the example shown, display objects 2504, 2506 are graphic representations of system objects. Some examples of system objects include device functions, applications, windows, files, alerts, events, or other identifiable system objects.

### Example Mobile Device Functionality

In some implementations, mobile device 2500 can implement multiple device functionalities, such as a telephony device, as indicated by Phone object 2510; an e-mail device, as indicated by Mail object 2512; a map device, as indicated by Maps object 2514; a Wi-Fi base station device (not shown); and a network video transmission and display device, as indicated by Web Video object 2516. In some implementations, particular display objects 2504 (e.g., Phone object 2510, Mail object 2512, Maps object 2514, and Web Video object 2516) can be displayed in menu bar 2518. In some implementations, device functionalities can be accessed from a top-level graphical user interface, such as the graphical user interface illustrated in FIG. 4A. Touching one of objects 2510, 2512, 2514, or 2516 can, for example, invoke a corresponding functionality.

In some implementations, mobile device 2500 can implement a network distribution functionality. For example, the functionality can enable the user to take mobile device 2500 and provide access to its associated network while traveling. In particular, mobile device 2500 can extend Internet access (e.g., Wi-Fi) to other wireless devices in the vicinity. For example, mobile device 2500 can be configured as a base station for one or more devices. As such, mobile device 2500 can grant or deny network access to other wireless devices.

In some implementations, upon invocation of a device functionality, the graphical user interface of mobile device 2500 can change, or can be augmented or replaced with another user interface or user interface elements to facilitate user access to particular functions associated with the corresponding device functionality. For example, in response to a user touching Phone object 2510, the graphical user interface of touch-sensitive display 2502 may present display objects related to various phone functions. Likewise, touching of Mail object 2512 may cause the graphical user interface to present display objects related to various e-mail functions, touching Maps object 2514 may cause the graphical user interface to present display objects related to various maps functions, and touching Web Video object 2516 may cause the graphical user interface to present display objects related to various web video functions.

In some implementations, the top-level graphical user interface environment or state of FIG. 4A can be restored by pressing button 2520 located near the bottom of mobile device 2500. In some implementations, each corresponding device functionality may have corresponding “home” display objects displayed on touch-sensitive display 2502, and the graphical user interface environment of FIG. 4A can be restored by pressing the “home” display object.

In some implementations, the top-level graphical user interface can include additional display objects 2506, such as short messaging service (SMS) object 2530, Calendar object 2532, Photos object 2534, Camera object 2536, Calculator object 2538, Stocks object 2540, Address Book object 2542, Media object 2544, Web object 2546, Video object 2548, Settings object 2550, and Notes object (not shown). Touching SMS display object 2530 can, for example, invoke an SMS messaging environment and supporting functionality; likewise, each selection of display object 2532, 2534, 2536, 2538, 2540, 2542, 2544, 2546, 2548, 2550 can invoke a corresponding object environment and functionality.

Additional and/or different display objects can also be displayed in the graphical user interface of FIG. 4A. For example, if mobile device 2500 is functioning as a base station for other devices, one or more “connection” objects may appear in the graphical user interface to indicate the connection. In some implementations, display objects 2506 can be configured by a user, e.g., a user may specify which display objects 2506 are displayed, and/or may download additional applications or other software that provides other functionalities and corresponding display objects.

In some implementations, mobile device 2500 can include one or more input/output (I/O) devices and/or sensor devices. For example, speaker 2560 and microphone 2562 can be included to facilitate voice-enabled functionalities, such as phone and voice mail functions. In some implementations, up/down button 2584 for volume control of speaker 2560 and microphone 2562 can be included. Mobile device 2500 can also include on/off button 2582 for a ring indicator of incoming phone calls. In some implementations, loud speaker 2564 can be included to facilitate hands-free voice functionalities, such as speaker phone functions. Audio jack 2566 can also be included for use of headphones and/or a microphone.

In some implementations, proximity sensor 2568 can be included to facilitate the detection of the user positioning mobile device 2500 proximate to the user's ear and, in response, to disengage touch-sensitive display 2502 to prevent accidental function invocations. In some implementations, touch-sensitive display 2502 can be turned off to conserve additional power when mobile device 2500 is proximate to the user's ear.

Other sensors can also be used. For example, in some implementations, ambient light sensor 2570 can be utilized to facilitate adjusting brightness of touch-sensitive display 2502. In some implementations, accelerometer 2572 can be utilized to detect movement of mobile device 2500, as indicated by directional arrow 2574. Accordingly, display objects and/or media can be presented according to a detected orientation (e.g., portrait or landscape). In some implementations, mobile device 2500 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into mobile device 2500 or provided as a separate device that can be coupled to mobile device 2500 through an interface (e.g., port device 2590) to provide access to location-based services.

In some implementations, port device 2590 (e.g., a Universal Serial Bus (USB) port, or a docking port, or some other wired port connection) can be included. Port device 2590 can, for example, be utilized to establish a wired connection to other computing devices, such as other mobile devices 2500, network access devices, a personal computer, a printer, a display screen, or other processing devices capable of receiving and/or transmitting data. In some implementations, port device 2590 allows mobile device 2500 to synchronize with a host device using one or more protocols, such as, for example, the TCP/IP, HTTP, UDP and any other known protocol.

Mobile device 2500 can also include camera lens and sensor 2580. In some implementations, camera lens and sensor 2580 can be located on the back surface of mobile device 2500. The camera can capture still images and/or video.

Mobile device 2500 can also include one or more wireless communication subsystems, such as 802.11b/g communication device 2586, and/or Bluetooth™ communication device 2588. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Configurable Top-Level Graphical User Interface

FIG. 4B illustrates another example of configurable top-level graphical user interface of mobile device 2500. Mobile device 2500 can be configured to display a different set of display objects.

In some implementations, each of one or more system objects of mobile device 2500 has a set of system object attributes associated with it; and one of the attributes determines whether a display object for the system object will be rendered in the top-level graphical user interface. This attribute can be set by the system automatically, or by a user through certain programs or system functionalities as described below. FIG. 4B shows an example of how Notes object 2552 (not shown in FIG. 4A) is added to, and Web Video object 2516 is removed from, the top graphical user interface of mobile device 2500 (e.g., such as when the attributes of the Notes system object and the Web Video system object are modified).

### Example Mobile Device Architecture

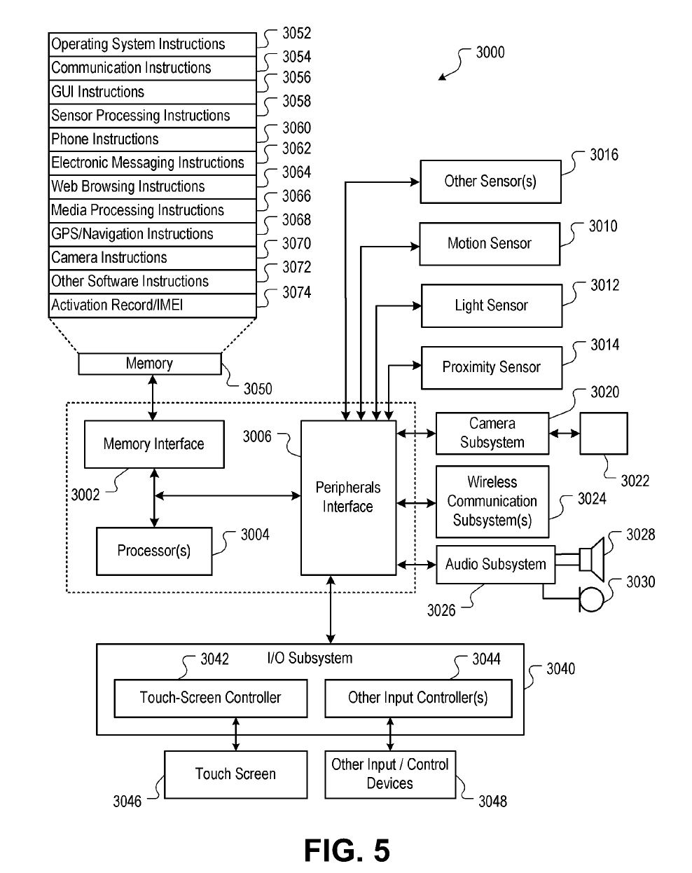

FIG. 5 is a block diagram 3000 of an example implementation of a mobile device (e.g., mobile device 2500). The mobile device can include memory interface 3002, one or more data processors, image processors and/or central processing units 3004, and peripherals interface 3006. Memory interface 3002, one or more processors 3004 and/or peripherals interface 3006 can be separate components or can be integrated in one or more integrated circuits. The various components in the mobile device can be coupled by one or more communication buses or signal lines.

Sensors, devices, and subsystems can be coupled to peripherals interface 3006 to facilitate multiple functionalities. For example, motion sensor 3010, light sensor 3012, and proximity sensor 3014 can be coupled to peripherals interface 3006 to facilitate the orientation, lighting, and proximity functions described with respect to FIG. 4A. Other sensors 3016 can also be connected to peripherals interface 3006, such as a positioning system (e.g., GPS receiver), a temperature sensor, a biometric sensor, or other sensing device, to facilitate related functionalities.

Camera subsystem 3020 and optical sensor 3022 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 3024, which can include radio frequency receivers and transmitters and/or optical (e.g., infrared) receivers and transmitters. The specific design and implementation of communication subsystem 3024 can depend on the communication network(s) over which the mobile device is intended to operate. For example, a mobile device can include communication subsystems 3024 designed to operate over a GSM network, a GPRS network, an EDGE network, a Wi-Fi or WiMax network, and a Bluetooth™ network. In particular, wireless communication subsystems 3024 may include hosting protocols such that the mobile device may be configured as a base station for other wireless devices.

Audio subsystem 3026 can be coupled to speaker 3028 and microphone 3030 to facilitate voice-enabled functions, such as voice recognition, voice replication, digital recording, and telephony functions.

I/O subsystem 3040 can include touch screen controller 3042 and/or other input controller(s) 3044. Touch-screen controller 3042 can be coupled to touch screen 3046. Touch screen 3046 and touch screen controller 3042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 3046.

Other input controller(s) 3044 can be coupled to other input/control devices 3048, such as one or more buttons, rocker switches, thumb-wheel, infrared port, USB port, and/or a pointer device such as a stylus. The one or more buttons (not shown) can include an up/down button for volume control of speaker 3028 and/or microphone 3030.

In one implementation, a pressing of the button for a first duration may disengage a lock of touch screen 3046, and a pressing of the button for a second duration that is longer than the first duration may turn power to the mobile device on or off. The user may be able to customize a functionality of one or more of the buttons. Touch screen 3046 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod . Other input/output and control devices can also be used.

Memory interface 3002 can be coupled to memory 3050. Memory 3050 can include high-speed random access memory and/or non-volatile memory, such as one or more magnetic disk storage devices, one or more optical storage devices, and/or flash memory (e.g., NAND, NOR). Memory 3050 can store operating system 3052, such as Darwin, RTXC, LINUX, UNIX, OS X, WINDOWS, or an embedded operating system such as VxWorks. Operating system 3052 may include instructions for handling basic system services and for performing hardware dependent tasks. In some implementations, operating system 3052 can be a kernel (e.g., UNIX kernel).

Memory 3050 may also store communication instructions 3054 to facilitate communicating with one or more additional devices, one or more computers and/or one or more servers. Memory 3050 may include graphical user interface instructions 3056 to facilitate graphic user interface processing; sensor processing instructions 3058 to facilitate sensor-related processing and functions; phone instructions 3060 to facilitate phone-related processes and functions; electronic messaging instructions 3062 to facilitate electronic-messaging related processes and functions; web browsing instructions 3064 to facilitate web browsing-related processes and functions; media processing instructions 3066 to facilitate media processing-related processes and functions; GPS/Navigation instructions 3068 to facilitate GPS and navigation-related processes and instructions; camera instructions 3070 to facilitate camera-related processes and functions; and/or other software instructions 3072 to facilitate other processes and functions (e.g., access control management functions). Memory 3050 may also store other software instructions (not shown), such as web video instructions to facilitate web video-related processes and functions and/or web shopping instructions to facilitate web shopping-related processes and functions. In some implementations, media processing instructions 3066 may be divided into audio processing instructions and video processing instructions, for example to facilitate audio processing-related processes and functions and video processing-related processes and functions, respectively. Activation record and International Mobile Equipment Identity (IMEI) 3074 or similar hardware identifier can also be stored in memory 3050.

Each of the above identified instructions and applications can correspond to a set of instructions for performing one or more functions described above. These instructions need not be implemented as separate software programs, procedures, or modules. Memory 3050 can include additional instructions or fewer instructions. Furthermore, various functions of the mobile device may be implemented in hardware and/or in software, including in one or more signal processing and/or application specific integrated circuits.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal), that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code).

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube), LCD (liquid crystal display) monitor, touch sensitive device or display, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method of processing audio, said method comprising:
receiving compressed and uncompressed audio from a plurality of applications; and
arbitrating access to hardware resources for the compressed and uncompressed audio.

2. The method of claim 1, wherein arbitrating access to the hardware resources comprises reducing delay during playback of the compressed and uncompressed audio.

3. The method of claim 1, wherein arbitrating access to the hardware resources comprises reducing delay during recording of the compressed and uncompressed audio.

4. A method of processing audio, said method comprising:
arranging different sets of audio into respective buffers; and
scheduling at least one command in advance of playback of audio in one of the respective buffers.

5. The method of claim 2, wherein scheduling the at least one command comprises scheduling a command for switching playback of one format of audio to another format.

6. The method of claim 2, wherein scheduling the at least one command comprises scheduling a command for an audio buffer to be played during playback of a current audio buffer.

7. A computing device for providing high quality playback of media content, the computing device comprising:
a computer memory that stores one or more blocks of a media file; and
a processor programmed to read the one or more blocks before a playback time of the one or more blocks and execute processing instructions for the one or more blocks in advance of the playback time such that the processing time of the one or more blocks during playback is reduced.

8. The computing device of claim 7, wherein the processing instructions comprises instructions that decode a digital data stream.

9. The computing device of claim 7, wherein the processing instructions comprises instructions that decrypt digital rights management technology.

10. The computing device of claim 7, wherein the media file comprises audio content.

11. The computing device of claim 7, wherein the media file comprises video content.

12. A computer-readable medium having stored thereon instructions that, when executed by a computer, cause a computer to:
place a buffer that holds media content for processing on the computer in a buffer queue; and
tag the buffer with one or more commands in a command queue that are executed in advance of the media content to expedite the processing of the media content.

13. The computer-readable medium of claim 12, wherein the one or more commands are executed before the media content is scheduled for playback.

14. The computer-readable medium of claim 12, wherein the one or more commands transitions to a different media type.

15. The computer-readable medium of claim 12, wherein the one or more commands decodes media content with digital rights management technology.

16. The computer-readable medium of claim 12, wherein the one or more commands decompresses the media content.

17. The computer-readable medium of claim 12, wherein the one or more commands decrypts the media content.

18. The computer-readable medium of claim 12, wherein the processing comprises playing the media content.

19. The computer-readable medium of claim 12, wherein the processing comprises recording the media content.

20. The computer-readable medium of claim 12, wherein the processing comprises storing the media content.
